(19) United States
(12) Patent Application Publication
(10) Pub. No.: US 2025/0071243 A1
(43) Pub. Date: Feb. 27, 2025

(54) CONTROL DEVICE, MOVING OBJECT, CONTROL METHOD, AND CONTROL PROGRAM

(71) Applicant: FUJIFILM Corporation, Tokyo (JP)

(72) Inventors: Masahiko MIYATA, Saitama-shi (JP); Kazuki ISHIDA, Saitama-shi (JP); Kazuki INOUE, Saitama-shi (JP)

(73) Assignee: FUJIFILM Corporation, Tokyo (JP)

(21) Appl. No.: 18/949,005

(22) Filed: Nov. 15, 2024

Related U.S. Application Data
(63) Continuation of application No. PCT/JP2023/015199, filed on Apr. 14, 2023.

(30) Foreign Application Priority Data
May 18, 2022 (JP) 2022-081603

(51) Int. Cl. H04N 9/31

(52) U.S. Cl. CPC H04N 9/3194; H04N 9/3173; H04N 9/3182; H04N 9/3185; H04N 9/3188

(57) ABSTRACT

A control device includes a processor. The processor is configured to: instruct a projection apparatus to project a first image to a projection surface; acquire a second image obtained by imaging the projection surface via an imaging apparatus; detect a specific marker from the second image; and change a partial region of the first image based on a position of the marker, and change the partial region such that visibility of the marker is reduced.

### CROSS-REFERENCE TO RELATED APPLICATIONS

This is a continuation of International Application No. PCT/JP2023/015199 filed on Apr. 14, 2023, and claims priority from Japanese Patent Application No. 2022-081603 filed on May 18, 2022, the entire content of which is incorporated herein by reference.

### BACKGROUND OF THE INVENTION

### 1. Field of the Invention

The present invention relates to a control device, a moving object, a control method, and a computer-readable storage medium storing a control program.

### 2. Description of the Related Art

JP2020-134895A discloses a display method including acquiring marker information indicating a feature of a marker, generating correspondence information for associating a display target image with the marker information, detecting a position and the feature of the marker disposed on a screen by a projector, specifying the associated image based on the marker information corresponding to the detected feature of the marker and on the correspondence information, determining a display position of the image based on the detected position of the marker, and displaying the specified image at the determined display position.

JP2019-004368A discloses a projection apparatus that performs a control such as switching between an operation state and a rest state of projection means and changing a display aspect of an image displayed on a projection surface, based on a shape of a marker read from the projection surface.

JP2016-188892A discloses a projector that projects a projection image including an object image to a screen, detects a size of a region to which the projection image is projected, detects an operation of an indicator with respect to the screen, and in a case where the detected operation of the indicator is an operation of moving the object image, varies a moving amount of the object image in accordance with the size of the region to which the image is projected.

JP2005-039518A discloses a projection-type projector in which a marker irradiation unit for irradiating a screen with a marker as a reference for adjusting a position of a projection image is provided in a remote control transmitter, a detection sensor is provided in a projector body and detects the marker with which the screen is irradiated, and the projector body moves an image projection position by scaling an image signal to be input into a display element such that an upper end or a lower end of the projection image matches the marker detected by the detection sensor.

### SUMMARY OF THE INVENTION

One embodiment according to the disclosed technology provides a control device, a moving object, a control method, and a computer-readable storage medium storing a control program that can control visibility of a position of a marker displayed on a projection surface together with a projection image.
(1)
A control device comprises a processor, in which the processor is configured to instruct a projection apparatus to project a first image to a projection surface, acquire a second image obtained by imaging the projection surface via an imaging apparatus, detect a specific marker from the second image, and change a partial region of the first image based on a position of the marker.
(2)
In the control device according to (1), the processor is configured to change the partial region such that visibility of the marker is reduced.
(3)
In the control device according to (1), the processor is configured to change the partial region such that visibility of the marker is increased.
(4)
In the control device according to any one of (1) to (3), the processor is configured to display a specific symbol image in the partial region of the first image.
(5)
In the control device according to (4), the processor is configured to change a position of the symbol image in the first image in accordance with a change in the position of the marker.
(6)
In the control device according to (5), the processor is configured to, in a case where the change in the position of the marker satisfies a predetermined condition, not change the position of the symbol image in the first image in accordance with the change in the position of the marker.
(7)
In the control device according to (6), the processor is configured to change the predetermined condition based on at least any of a size or brightness of the detected marker.
(8)
In the control device according to (6), the processor is configured to change a size of the symbol image in the first image based on at least any of a size or brightness of the detected marker.
(9)
In the control device according to any one of (5) to (8), the processor is configured to display an image representing a path of a change in a position of the symbol image in the first image, on the first image.
(10)
In the control device according to any one of (5) to (9), the processor is configured to generate history data of a change of the symbol image in the first image.
(11)
In the control device according to any one of (5) to (10), the processor is configured to restrict a direction of a change in the position of the symbol image in the first image.
(12)
In the control device according to any one of (5) to (11), the processor is configured to change the symbol image based on the change in the position of the marker in the first image.
(13)
In the control device according to any one of (5) to (12), the processor is configured to hold the position of the symbol image in a case where the detected marker is not detectable anymore.
(14)
In the control device according to any one of (5) to (13), the processor is configured to, in a case where the position of the symbol image in the first image is not changeable anymore in accordance with the change in the position of the marker, display the symbol image at a position corresponding to the position of the marker in a region of the first image in which the symbol image is displayable.
(15)
In the control device according to any one of (4) to (14), the processor is configured to change the symbol image based on a state of the marker.
(16)
In the control device according to (15), the state of the marker includes at least any of a color of the marker, a shape of the marker, a size of the marker, or a period of blinking display of the marker.
(17)
In the control device according to any one of (4) to (16), the processor is configured to display the symbol image at a position different from the position of the marker in the first image in accordance with a difference between a first region to which the first image is projected on the projection surface and a second region in which the marker is detectable on the projection surface, and in a case where the marker is present in the first region, change the partial region such that visibility of the marker is reduced.
(18)
In the control device according to any one of (1) to (17), the processor is configured to, in a case where the detected marker is not detectable anymore, display an image indicating that the marker is not detectable, on the first image.
(19)
In the control device according to any one of (1) to (18), the marker is provided by an invisible ray projected to the projection surface.
(20)
In the control device according to any one of (1) to (19), the processor is configured to instruct the projection apparatus to change at least any of a position or a size of a projection region in accordance with a detection result of the marker.
(21)
In the control device according to any one of (1) to (20), the processor is configured to instruct the projection apparatus to cause the first image to blink.
(22)
A moving object comprises the control device according to any one of (1) to (21), the projection apparatus, and the imaging apparatus, in which the control device is capable of performing a moving control of the moving object.
(23)
In the moving object according to (22), the processor is configured to perform the moving control for changing at least any of a position or a size of a projection region of the projection apparatus in accordance with a detection result of the marker.
(24)
A control method comprises, via a processor, instructing a projection apparatus to project a first image to a projection surface, acquiring a second image obtained by imaging the projection surface via an imaging apparatus, detecting a specific marker from the second image, and changing a partial region of the first image based on a position of the marker.
(25)
A non-transitory computer-readable storage medium stores a control program that causes a processor to execute a process comprising instructing a projection apparatus to project a first image to a projection surface, acquiring a second image obtained by imaging the projection surface via an imaging apparatus, detecting a specific marker from the second image, and changing a partial region of the first image based on a position of the marker.

According to the present invention, a control device, a moving object, a control method, and a control program that can control visibility of a position of a marker displayed on a projection surface together with a projection image can be provided.

### BRIEF DESCRIPTION OF THE DRAWINGS

FIG. 1 is a diagram illustrating an example of a moving object 10 to which a control device according to an embodiment of the present invention can be applied.

FIG. 2 is a diagram illustrating an example of a configuration of the moving object 10.

FIG. 3 is a schematic diagram illustrating an example of an internal configuration of a projection apparatus 11.

FIG. 4 is a diagram illustrating an example of a hardware configuration of an information terminal 40.

FIG. 5 is a diagram illustrating an example of a projection region of the projection apparatus 11 and an imaging range of an imaging apparatus 12.

FIG. 6 is a diagram illustrating an example of irradiation of a projection surface 6a with an instruction marker.

FIG. 7 is a flowchart illustrating an example of processing performed by a control device 14.

FIG. 8 is a diagram illustrating a first example of changing of a partial region of a projection image 11b based on a position of an instruction marker 61.

FIG. 9 is a diagram illustrating a second example of changing of the partial region of the projection image 11b based on the position of the instruction marker 61.

FIG. 10 is a diagram illustrating a third example of changing of the partial region of the projection image 11b based on the position of the instruction marker 61.

FIG. 11 is a diagram illustrating a fourth example of changing of the partial region of the projection image 11b based on the position of the instruction marker 61.

FIG. 12 is a diagram illustrating a fifth example of changing of the partial region of the projection image 11b based on the position of the instruction marker 61.

FIG. 13 is a diagram illustrating an example of movement of a symbol image 11d corresponding to movement of the instruction marker 61.

FIG. 14 is a diagram illustrating an example of the symbol image 11d that does not follow the instruction marker 61 with a shaky hand or the like.

FIG. 15 is a diagram illustrating an example of changing of a predetermined condition based on a size or the like of the detected instruction marker 61.

FIG. 16 is a diagram illustrating an example of changing of a size of the symbol image 11d based on the size or the like of the detected instruction marker 61.

FIG. 17 is a diagram illustrating an example of display of a path of the movement of the symbol image 11d.

FIG. 18 is a diagram illustrating an example of restriction of a direction of a change in a position of the symbol image 11d in the projection image 11b.

FIG. 19 is a diagram illustrating an example of changing of the symbol image 11d based on a change in the position of the instruction marker 61.

FIG. 20 is a diagram illustrating an example of holding of the position of the symbol image 11d in a case where the instruction marker 61 is not detectable anymore.

FIG. 21 is a diagram illustrating an example of display of an image indicating an inability to detect the instruction marker 61.

FIG. 22 is a diagram illustrating an example of display of the symbol image 11d in a case where the position of the symbol image 11d is not changeable anymore.

FIG. 23 is a diagram illustrating an example of display of the symbol image 11d at a position different from the position of the instruction marker 61.

FIG. 24 is a flowchart illustrating another example of the processing performed by the control device 14.

FIG. 25 is a diagram illustrating an example of changing of a position of a projection region 11a by moving the instruction marker 61.

### DESCRIPTION OF THE PREFERRED EMBODIMENTS

Hereinafter, an example of an embodiment of the present invention will be described with reference to the drawings.

### EMBODIMENT

### Moving Object 10 to Which Control Device According to Embodiment of Present Invention Can Be Applied

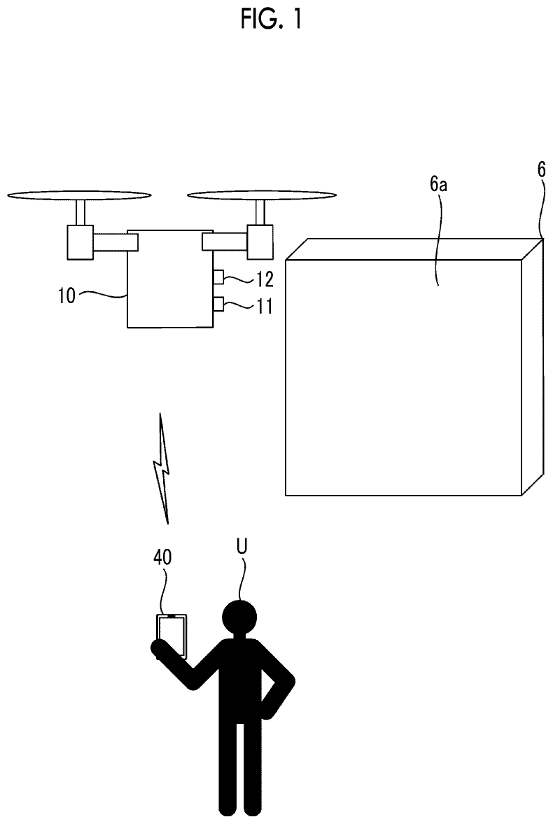

FIG. 1 is a diagram illustrating an example of a moving object 10 to which a control device according to the embodiment of the present invention can be applied. As illustrated in FIG. 1, the moving object 10 is a movable flying object and is, for example, an unmanned aerial vehicle also referred to as a drone. For example, the moving object 10 is a multicopter including three or more rotors (for example, four rotors).

A projection apparatus 11 and an imaging apparatus 12 are mounted on the moving object 10. The projection apparatus 11 is a projection apparatus that can perform projection to a projection target object 6. The imaging apparatus 12 can image the projection target object 6. The projection target object 6 is an object such as a wall and has a projection surface 6a as a target for the projection performed by the projection apparatus 11. In the example illustrated in FIG. 1, the projection target object 6 is a rectangular cuboid.

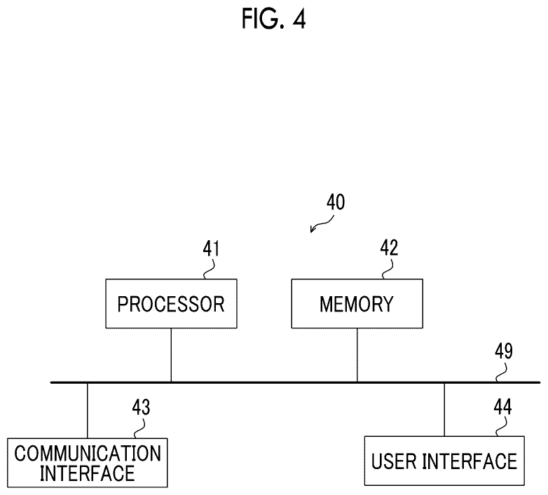

An information terminal 40 is an information terminal carried by a user U. The information terminal 40 can communicate with the moving object 10. In the example in FIG. 1, the information terminal 40 is a tablet terminal. The information terminal 40 is not limited to a tablet terminal and can be various information terminals such as a smartphone, a laptop personal computer, and a desktop personal computer. A configuration of the information terminal 40 will be described with reference to FIG. 4. The user U can perform various controls of the moving object 10 by operating the information terminal 40.

### <Configuration of Moving Object 10>

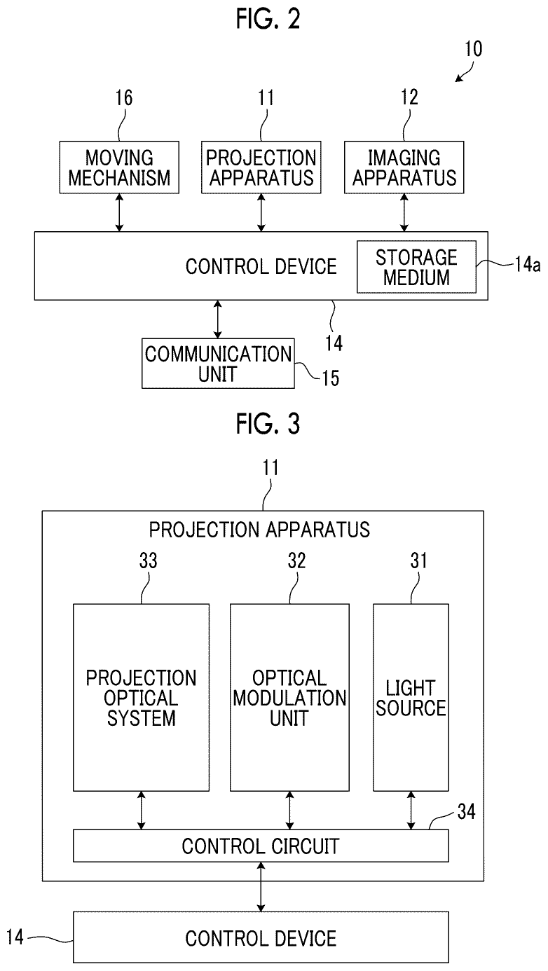

FIG. 2 is a diagram illustrating an example of a configuration of the moving object 10. As illustrated in FIG. 2, the moving object 10 comprises, for example, the projection apparatus 11, the imaging apparatus 12, a control device 14, a communication unit 15, and a moving mechanism 16.

The projection apparatus 11 is composed of, for example, a liquid crystal projector or a projector using liquid crystal on silicon (LCOS). Hereinafter, the projection apparatus 11 will be described as a liquid crystal projector.

The imaging apparatus 12 is an imaging unit including an imaging lens and an imaging element. For example, a complementary metal-oxide-semiconductor (CMOS) image sensor can be used as the imaging element.

The control device 14 performs various controls in the moving object 10. The control device 14 is an example of the control device according to the embodiment of the present invention. Examples of the controls of the control device 14 include a control of the projection performed by the projection apparatus 11, a control of imaging performed by the imaging apparatus 12, a control of communication performed by the communication unit 15, and a moving control of the moving object 10 performed by the moving mechanism 16.

The control device 14 is a device including a control unit composed of various processors, a communication interface (not illustrated) for communicating with each unit of the moving object 10, and a storage medium 14a such as a hard disk, a solid state drive (SSD), or a read only memory (ROM) and manages and controls the moving object 10. Examples of the various processors of the control unit of the control device 14 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

A structure of the various processors is more specifically an electric circuit in which circuit elements such as semiconductor elements are combined. The control unit of the control device 14 may be composed of one of the various processors or may be composed of a combination of two or more processors of the same type or different types (for example, a combination of a plurality of FPGAs or a combination of a CPU and an FPGA).

The communication unit 15 is a communication interface that can communicate with other apparatuses. For example, the communication unit 15 is a wireless communication interface that can perform wireless communication with the information terminal 40 on the ground while the moving object 10 is flying.

The moving mechanism 16 is a mechanism for moving the moving object 10. For example, in a case where the moving object 10 is a multicopter, the moving mechanism 16 includes four rotors, actuators such as motors that rotate the rotors, respectively, and a control circuit that controls each actuator. The number of rotors or the like included in the moving mechanism 16 may be three or may be five or more.

The projection apparatus 11, the imaging apparatus 12, the control device 14, the communication unit 15, and the moving mechanism 16 are implemented as, for example, one apparatus mounted on the moving object 10. Alternatively, the projection apparatus 11, the imaging apparatus 12, the control device 14, the communication unit 15, and the moving mechanism 16 may be implemented by a plurality of apparatuses that are mounted on the moving object 10 and that can cooperate with each other by communicating with each other.

### <Internal Configuration of Projection Apparatus 11>

FIG. 3 is a schematic diagram illustrating an example of an internal configuration of the projection apparatus 11. The projection apparatus 11 of the moving object 10 illustrated in FIG. 2 comprises a light source 31, an optical modulation unit 32, a projection optical system 33, and a control circuit 34, as illustrated in FIG. 3. The light source 31 includes a light emitting element such as a laser or a light emitting diode (LED) and emits, for example, white light.

The optical modulation unit 32 is composed of three liquid crystal panels (optical modulation elements) that emit each color image by modulating each color light which is emitted from the light source 31 and which is separated into three colors of red, blue, and green by a color separation mechanism, not illustrated, based on image information, and a dichroic prism that mixes each color image emitted from the three liquid crystal panels and that emits the mixed color image in the same direction. Each color image may be emitted by mounting filters of red, blue, and green in the three liquid crystal panels, respectively, and modulating the white light emitted from the light source 31 using each liquid crystal panel.

The light from the light source 31 and the optical modulation unit 32 is incident on the projection optical system 33. The projection optical system 33 includes at least one lens and is composed of, for example, a relay optical system. The light that has passed through the projection optical system 33 is projected to the projection target object 6.

A region irradiated with the light transmitted through the entire range of the optical modulation unit 32 on the projection target object 6 is the projectable range to which the projection can be performed by the projection apparatus 11. A region with which the light actually transmitted from the optical modulation unit 32 is irradiated in the projectable range is a projection region of the projection apparatus 11. For example, a size, a position, and a shape of the projection region of the projection apparatus 11 are changed in the projectable range by controlling a size, a position, and a shape of the region through which the light is transmitted in the optical modulation unit 32.

The control circuit 34 projects an image based on display data input from the control device 14 to the projection target object 6 by controlling the light source 31, the optical modulation unit 32, and the projection optical system 33 based on the display data. The display data input into the control circuit 34 is composed of three pieces of data including red display data, blue display data, and green display data.

In addition, the control circuit 34 enlarges or reduces the projection region of the projection apparatus 11 by changing the projection optical system 33 based on an instruction input from the control device 14. In addition, the control circuit 34 may move the projection region of the projection apparatus 11 by changing the projection optical system 33 based on an instruction input from the control device 14.

In addition, the projection apparatus 11 comprises a shift mechanism that mechanically or optically moves the projection region of the projection apparatus 11 while maintaining an image circle of the projection optical system 33. The image circle of the projection optical system 33 is a region in which projection light incident on the projection optical system 33 correctly passes through the projection optical system 33 in terms of light fall-off, color separation, edge part curvature, and the like.

The shift mechanism is implemented by at least any of an optical system shift mechanism that performs optical system shifting or an electronic shift mechanism that performs electronic shifting.

The optical system shift mechanism is, for example, a mechanism that moves the projection optical system 33 in a direction perpendicular to an optical axis or a mechanism that moves the optical modulation unit 32 in the direction perpendicular to the optical axis instead of moving the projection optical system 33. In addition, the optical system shift mechanism may move the projection optical system 33 and move the optical modulation unit 32 in combination with each other.

The electronic shift mechanism is a mechanism that performs pseudo shifting of the projection region by changing a range through which the light is transmitted in the optical modulation unit 32.

In addition, the projection apparatus 11 may comprise a projection direction changing mechanism that moves the image circle of the projection optical system 33 and the projection region. The projection direction changing mechanism is a mechanism that changes a projection direction of the projection apparatus 11 by mechanically rotating to change a direction of the projection apparatus 11.

### <Hardware Configuration of Information Terminal 40>

FIG. 4 is a diagram illustrating an example of a hardware configuration of the information terminal 40. As illustrated in FIG. 4, for example, the information terminal 40 illustrated in FIG. 1 comprises a processor 41, a memory 42, a communication interface 43, and a user interface 44. The processor 41, the memory 42, the communication interface 43, and the user interface 44 are connected to each other through, for example, a bus 49.

The processor 41 is a circuit that performs signal processing and is, for example, a CPU that controls the entire information terminal 40. The processor 41 may be implemented by other digital circuits such as an FPGA and a digital signal processor (DSP). In addition, the processor 41 may be implemented by combining a plurality of digital circuits with each other.

The memory 42 includes, for example, a main memory and an auxiliary memory. The main memory is, for example, a random access memory (RAM). The main memory is used as a work area of the processor 41.

The auxiliary memory is, for example, a non-volatile memory such as a magnetic disk, an optical disc, or a flash memory. The auxiliary memory stores various programs for operating the information terminal 40. The programs stored in the auxiliary memory are loaded into the main memory and executed by the processor 41.

In addition, the auxiliary memory may include a portable memory that can be detached from the information terminal 40. Examples of the portable memory include a universal serial bus (USB) flash drive, a memory card such as a secure digital (SD) memory card, and an external hard disk drive.

The communication interface 43 is a communication interface that performs wireless communication with an outside of the information terminal 40 (for example, the communication unit 15 of the moving object 10). The communication interface 43 is controlled by the processor 41.

The user interface 44 includes, for example, an input device that receives an operation input from the user, and an output device that outputs information to the user. The input device can be implemented by, for example, a key (for example, a keyboard) or a remote controller. The output device can be implemented by, for example, a display or a speaker. In addition, the input device and the output device may be implemented by a touch panel or the like. The user interface 44 is controlled by the processor 41.

### <Projection Region of Projection Apparatus 11 and Imaging Range of Imaging Apparatus 12>

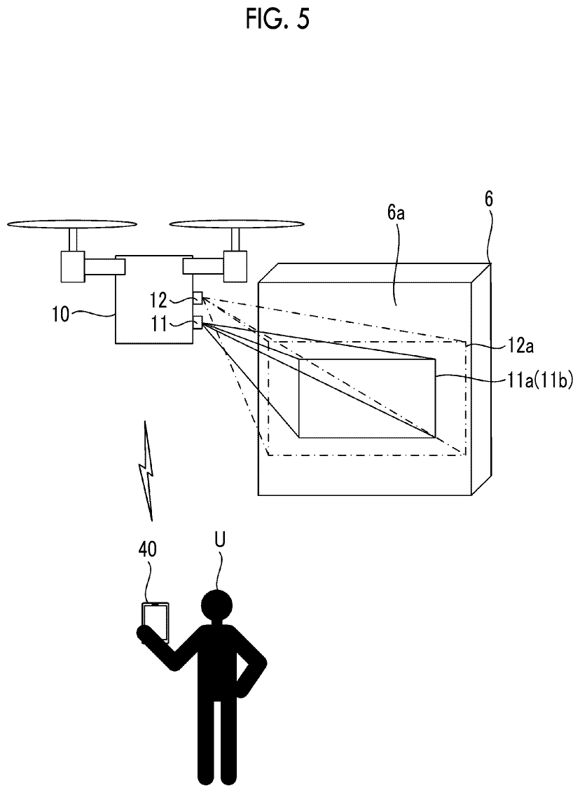

FIG. 5 is a diagram illustrating an example of the projection region of the projection apparatus 11 and an imaging range of the imaging apparatus 12. A projection region 11a illustrated in FIG. 5 is the projection region of the projection apparatus 11. That is, a projection image 11b as a projection target of the projection apparatus 11 is displayed in the projection region 11a. The projection image 11b may be a static image or a video.

The imaging range 12a is the imaging range of the imaging apparatus 12. That is, imaging data of the imaging range 12a is obtained by the imaging apparatus 12. The example in FIG. 5 indicates a relationship in which the imaging range 12a is larger than the projection region 11a and the imaging range 12a includes the projection region 11a.

<Irradiation of Projection Surface 6a with Instruction Marker>

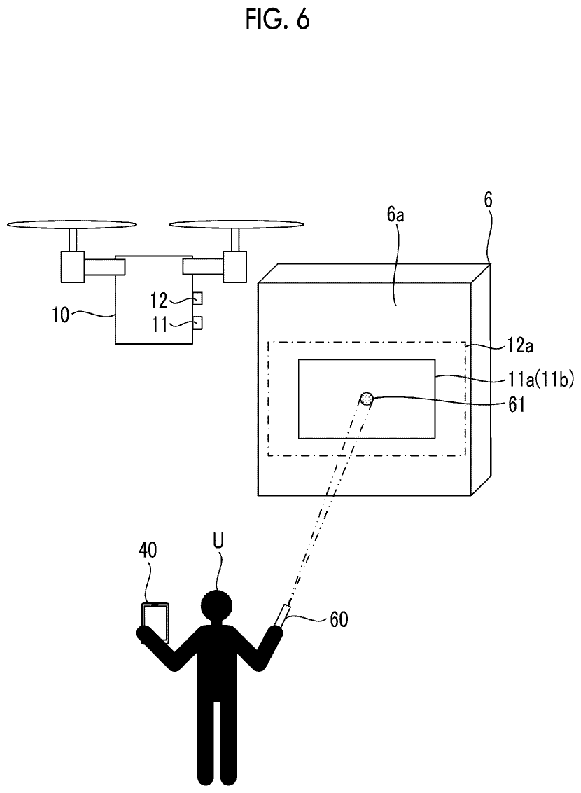

FIG. 6 is a diagram illustrating an example of irradiation of the projection surface 6a with an instruction marker. For example, the user U carries a laser pointer 60 and can irradiate the projection surface 6a with an instruction marker 61 using the laser pointer 60. For example, the instruction marker 61 is provided by visible light. The projection image 11b projected to the projection region 11a from the projection apparatus 11 desirably does not include an image similar to the instruction marker 61.

### <Processing Performed by Control Device 14>

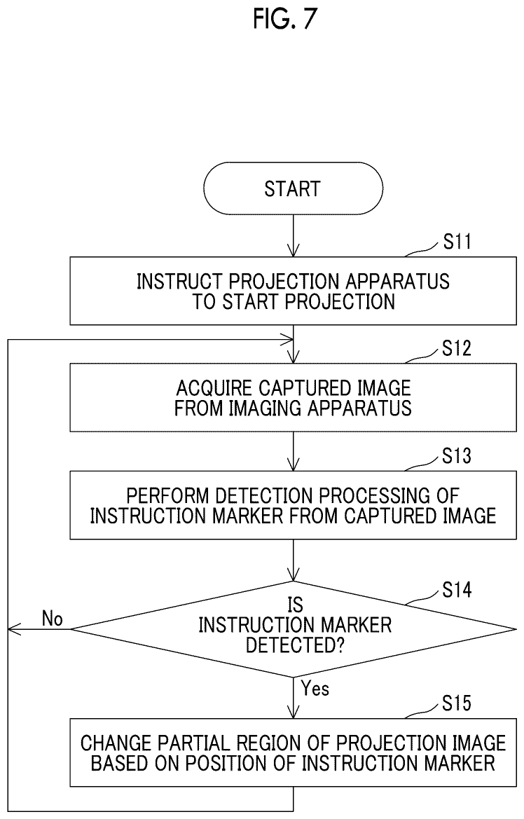

FIG. 7 is a flowchart illustrating an example of processing performed by the control device 14. The control device 14 executes, for example, processing illustrated in FIG. 7. First, the control device 14 instructs the projection apparatus 11 to start projecting the projection image 11b (step S11). This results in a state where the projection apparatus 11 projects the projection image 11b to the projection region 11a of the projection surface 6a.

Next, the control device 14 acquires a captured image of the imaging range 12a from the imaging apparatus 12 (step S12). For example, the control device 14 instructs the imaging apparatus 12 to perform the imaging in step S12 and acquires the captured image from the imaging apparatus 12. Alternatively, the imaging apparatus 12 may repeat the imaging of the imaging range 12a, and the control device 14 may acquire the captured image obtained by the imaging at a timing of step S12 from the imaging apparatus 12.

Next, the control device 14 performs detection processing of the instruction marker 61 from the captured image acquired in step S12 (step S13). The detection processing in step S13 is performed by, for example, image recognition processing based on the captured image.

Next, the control device 14 determines whether or not the instruction marker 61 is detected through the detection processing in step S13 (step S14). In a case where the instruction marker 61 is not detected (step S14: No), the control device 14 returns to step S12.

In step S14, in a case where the instruction marker 61 is detected (step S14: Yes), the control device 14 changes a partial region of the projection image 11b projected by the projection apparatus 11 based on a position of the detected instruction marker 61 (step S15), and returns to step S12. Hereinafter, specific examples of changing the partial region of the projection image 11b based on the position of the instruction marker 61 will be described.

### <Changing of Partial Region of Projection Image 11b Based on Position of Instruction Marker 61>

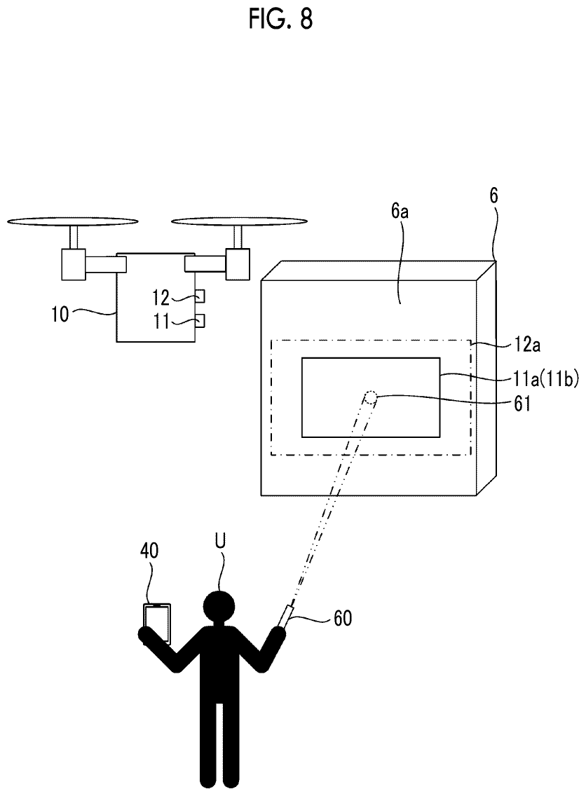

FIG. 8 is a diagram illustrating a first example of changing of the partial region of the projection image 11b based on the position of the instruction marker 61. In step S15 illustrated in FIG. 7, the control device 14 performs, for example, processing for reducing visibility of the instruction marker 61 with respect to the partial region of the projection image 11b.

Specifically, the control device 14 specifies a partial region (hereinafter, referred to as a “marker superimposition region”) of the projection image 11b projected by the projection apparatus 11 that is projected in an overlapping manner with the instruction marker 61 on the projection surface 6a.

For example, the control device 14 specifies the marker superimposition region of the projection image 11b based on a region of the instruction marker 61 in the captured image detected through the detection processing in step S13 and on information indicating a positional relationship between the projection region 11a and the imaging range 12a. The information indicating the positional relationship between the projection region 11a and the imaging range 12a is acquired based on, for example, a positional relationship between the projection apparatus 11 and the imaging apparatus 12 in the moving object 10, a projection parameter of the projection apparatus 11, and an imaging parameter of the imaging apparatus 12.

The control device 14 performs image processing of reducing the visibility of the instruction marker 61 by causing the instruction marker 61 to overlap with the marker superimposition region of the projection image 11b on the projection surface 6a. For example, the control device 14 can reduce the visibility of the instruction marker 61 by setting a color of the marker superimposition region to a color that appears to be the same as or similar to a color of an edge part region of the marker superimposition region after overlapping with the instruction marker 61.

For example, it is assumed that the edge part region of the marker superimposition region of the projection image 11b has an achromatic color (for example, gray), and a color of the instruction marker 61 is red. In this case, performing image processing of setting the color of the marker superimposition region of the projection image 11b to a blue-green color, which is a color complementary to red, causes the marker superimposition region overlapping with the instruction marker 61 to also appear to have an achromatic color (for example, gray), and the visibility of the instruction marker 61 on the projection surface 6a can be reduced.

As described above, the control device 14 instructs the projection apparatus 11 to project the projection image 11b (first image) to the projection surface 6a, acquires the captured image (second image) obtained by imaging the projection surface 6a via the imaging apparatus 12, detects the specific instruction marker 61 from the captured image, and changes the partial region (for example, the marker superimposition region) of the projection image 11b based on the position of the instruction marker 61. Accordingly, the visibility of the instruction marker 61 displayed on the projection surface 6a together with the projection image 11b can be controlled. For example, an effect of the instruction marker 61 on visibility of the projection image 11b can be suppressed by reducing the visibility of the instruction marker 61.

### Second Example of Changing of Partial Region of Projection Image 11b Based on Position of Instruction Marker 61

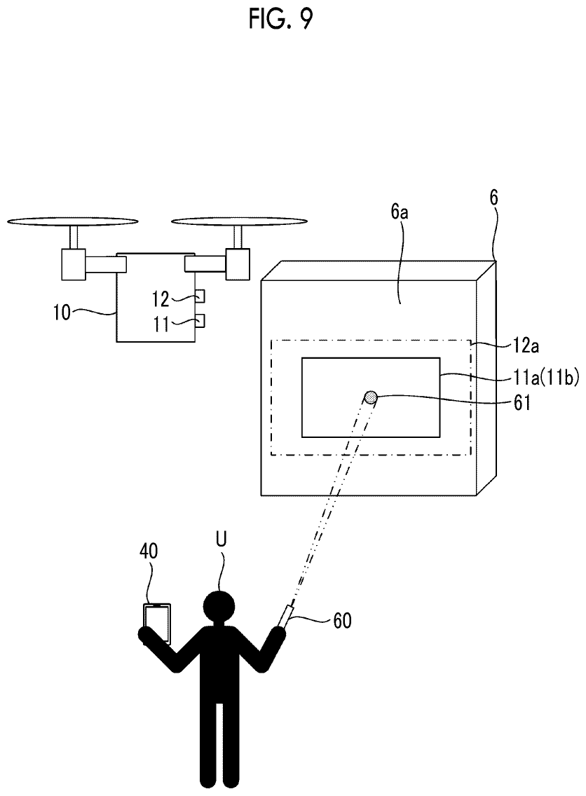

FIG. 9 is a diagram illustrating a second example of changing of the partial region of the projection image 11b based on the position of the instruction marker 61. In step S15 illustrated in FIG. 7, the control device 14 may perform, for example, processing for increasing the visibility of the instruction marker 61 with respect to the partial region of the projection image 11b.

Specifically, the control device 14 performs image processing of increasing the visibility of the instruction marker 61 by causing the instruction marker 61 to overlap with the marker superimposition region of the projection image 11b on the projection surface 6a. For example, the control device 14 sets brightness of the marker superimposition region to be lower than brightness of the edge part region of the marker superimposition region (for example, sets the brightness to 0).

Accordingly, an effect on the visibility of the instruction marker 61 caused by overlapping with the projection image 11b can be reduced, and, for example, as illustrated in FIG. 9, the visibility of the instruction marker 61 can be increased. By increasing the visibility of the instruction marker 61, an observer such as the user U can easily recognize the current position of the instruction marker 61.

### <Third Example of Changing of Partial Region of Projection Image 11b Based on

### Position of Instruction Marker 61>

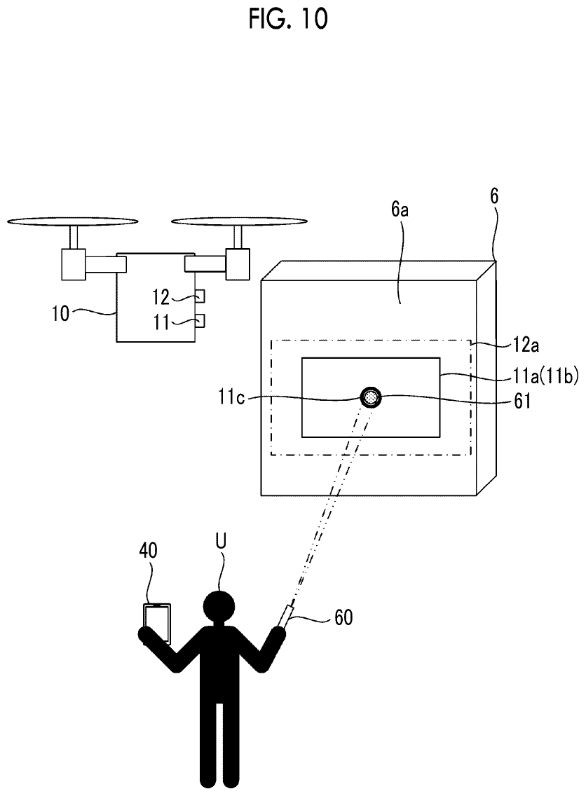

FIG. 10 is a diagram illustrating a third example of changing of the partial region of the projection image 11b based on the position of the instruction marker 61. In step S15 illustrated in FIG. 7, in order to increase the visibility of the instruction marker 61, the control device 14 may perform image processing of changing the edge part region of the marker superimposition region (the partial region based on the position of the instruction marker 61) of the projection image 11b.

For example, as illustrated in FIG. 10, the control device 14 may superimpose a highlight image 11c indicating the marker superimposition region on the projection image 11b. In the example in FIG. 10, the highlight image 11c is an annular image surrounding the marker superimposition region. However, the highlight image 11c is not limited to an annular image and may be an image of one or more arrows or the like indicating the marker superimposition region. Accordingly, a position of the marker superimposition region is highlighted, and the visibility of the instruction marker 61 can be increased.

### Fourth Example of Changing of Partial Region of Projection Image 11b Based on Position of Instruction Marker 61

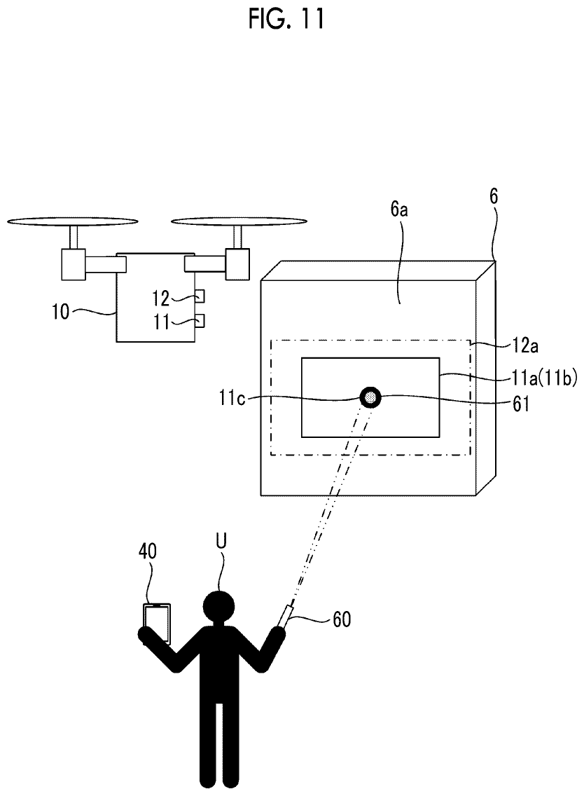

FIG. 11 is a diagram illustrating a fourth example of changing of the partial region of the projection image 11b based on the position of the instruction marker 61. In step S15 illustrated in FIG. 7, in order to increase the visibility of the instruction marker 61, the control device 14 may perform image processing of changing both of the marker superimposition region of the projection image 11b and the edge part region of the marker superimposition region of the projection image 11b.

For example, as illustrated in FIG. 11, the control device 14 sets the brightness of the marker superimposition region of the projection image 11b and brightness of a region surrounding the marker superimposition region of the projection image 11b to be lower than brightness of other regions of the projection image 11b (for example, sets the brightness to 0). Accordingly, the effect on the visibility of the instruction marker 61 caused by overlapping with the projection image 11b can be reduced as in the example in FIG. 9, and the marker superimposition region can be indicated as in the example in FIG. 10. Thus, the visibility of the instruction marker 61 can be increased.

### Fifth Example of Changing of Partial Region of Projection Image 11b Based on Position of Instruction Marker 61

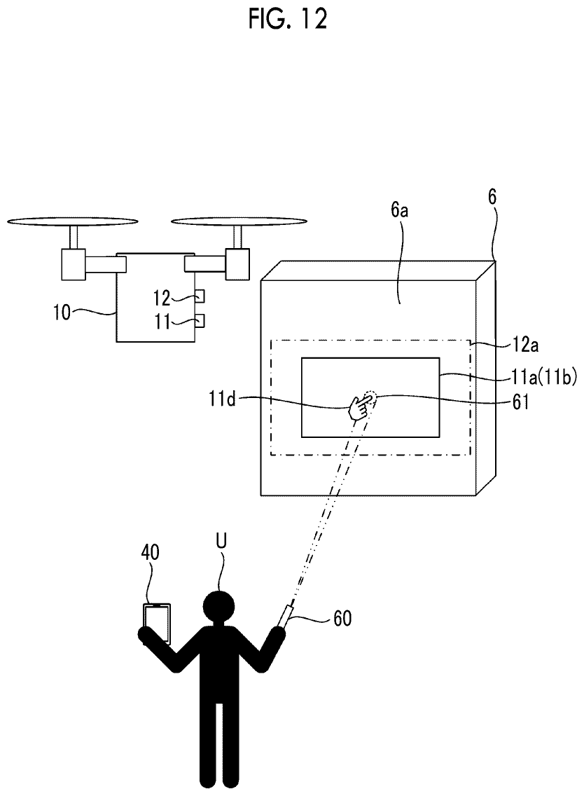

FIG. 12 is a diagram illustrating a fifth example of changing of the partial region of the projection image 11b based on the position of the instruction marker 61. In step S15 illustrated in FIG. 7, the control device 14 may display a specific symbol image in a superimposed manner on the marker superimposition region of the projection image 11b.

For example, as illustrated in FIG. 12, the control device 14 may display a symbol image 11d in a superimposed manner on the projection image 11b at the position of the marker superimposition region. In the example in FIG. 12, the symbol image 11d is an image of a finger of a person. For example, the control device 14 displays the symbol image 11d in a superimposed manner such that a reference position (for example, a center position) of the marker superimposition region matches a reference position (for example, a position of a fingertip) of the symbol image 11d.

Accordingly, the observer such as the user U can easily recognize the current position of the instruction marker 61, as in the case of increasing the visibility of the instruction marker 61. In addition, since the symbol image 11d is an image projected by the projection apparatus 11, the symbol image 11d can be a complicated image that is difficult to display as the instruction marker 61 based on the laser pointer 60. Thus, the current position of the instruction marker 61 can be more easily recognized. In addition, a stage effect achieved by displaying the symbol image 11d can be obtained.

In addition, in the example in FIG. 12, the control device 14 performs the processing for reducing the visibility of the instruction marker 61, as in the example in FIG. 8. Accordingly, an effect on visibility of the symbol image 11d caused by overlapping with the instruction marker 61 can be reduced, and the visibility of the symbol image 11d can be increased.

### <Movement of Symbol Image 11d Corresponding to Movement of Instruction Marker 61>

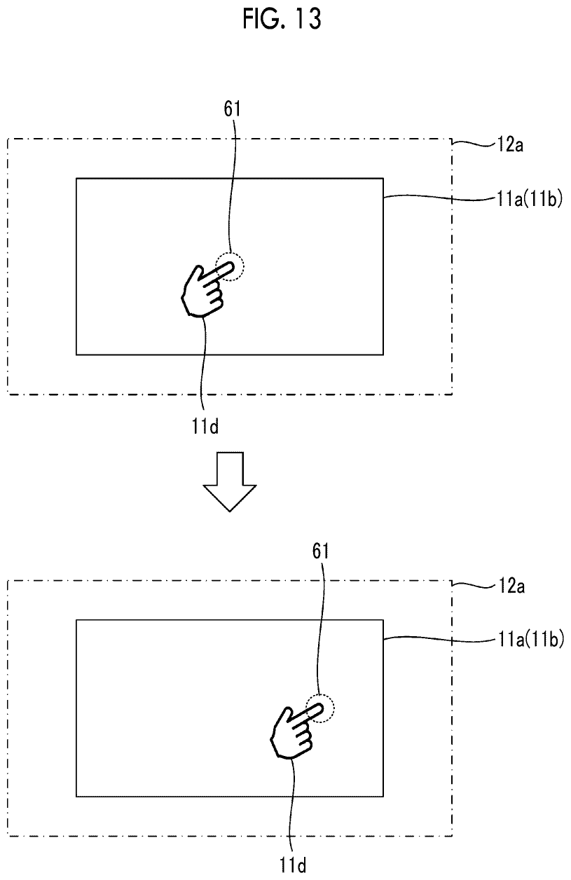

FIG. 13 is a diagram illustrating an example of movement of the symbol image 11d corresponding to movement of the instruction marker 61. By performing the processing (repeated processing) in FIG. 7, a position of the symbol image 11d moves following a change in the position of the instruction marker 61. For example, as illustrated in FIG. 13, in a case where the user U moves the instruction marker 61 in a rightward direction by operating the laser pointer 60, the symbol image 11d also moves in the rightward direction following the movement of the instruction marker 61.

As described above, the control device 14 changes the position of the symbol image 11d in the projection image 11b in accordance with the change in the position of the instruction marker 61. Accordingly, even in a case where the user U moves the instruction marker 61, the observer such as the user U can easily recognize the position of the instruction marker 61 after movement using the symbol image 11d.

<Symbol Image 11d That Does Not Follow Instruction Marker 61 with Shaky Hand or Like>

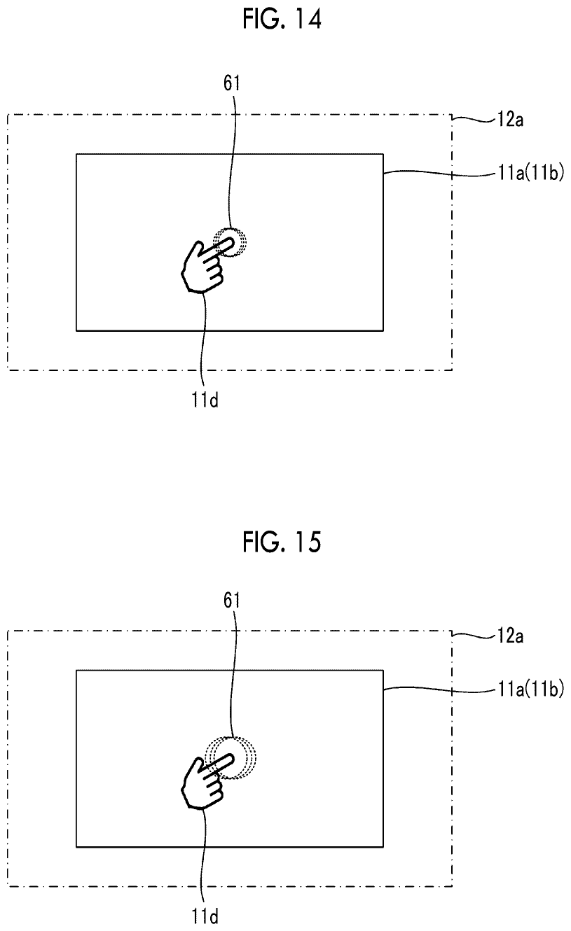

FIG. 14 is a diagram illustrating an example of the symbol image 11d that does not follow the instruction marker 61 with a shaky hand. For example, the control device 14 may perform low-pass filtering processing on a detection result of the position of the instruction marker 61 and cause the symbol image 11d to follow the instruction marker 61 in accordance with the detection result subjected to the low-pass filtering processing. Accordingly, for example, as in the example in FIG. 14, even in a case where the instruction marker 61 slightly shakes because of the laser pointer 60 held by the user U in the shaky hand or the like, the symbol image 11d can be made less likely to follow shaking of the instruction marker 61.

As described above, in a case where the change in the position of the instruction marker 61 satisfies a predetermined condition (for example, slight vibration at a high frequency), the control device 14 may not change the position of the symbol image 11d in the projection image 11b in accordance with the change in the position of the instruction marker 61. Accordingly, shaking of the symbol image 11d caused by the shaky hand or the like can be suppressed, and projection quality can be improved.

### <Changing of Predetermined Condition Based on Size or Like of Detected Instruction Marker 61>

FIG. 15 is a diagram illustrating an example of changing of the predetermined condition based on a size or the like of the detected instruction marker 61. In the example in FIG. 15, the instruction marker 61 in the imaging range 12a is large compared to that in the example in FIG. 14. In this case, the laser pointer 60 can be estimated to be positioned far from the projection surface 6a compared to that in the example in FIG. 14. In this case, the control device 14 may expand the predetermined condition of the change in the position of the instruction marker 61 for not changing the position of the symbol image 11d in the projection image 11b, compared to that in the example in FIG. 14.

For example, as the detected instruction marker 61 is larger, that is, as a situation where the laser pointer 60 is estimated to be positioned far from the projection surface 6a is more likely to occur, the control device 14 performs stronger low-pass filtering processing on the detection result of the position of the instruction marker 61.

Accordingly, as a situation where the laser pointer 60 is positioned far from the projection surface 6a and shaking of the instruction marker 61 caused by the shaky hand or the like is increased is more likely to occur, shaking of the symbol image 11d caused by the shaky hand or the like can be strongly suppressed by reducing sensitivity of the movement of the symbol image 11d with respect to the movement of the instruction marker 61.

In addition, as a situation where the laser pointer 60 is positioned close to the projection surface 6a and shaking of the instruction marker 61 caused by the shaky hand or the like is reduced is more likely to occur, an ability to cause the movement of the symbol image 11d to follow intended movement of the instruction marker 61 can be improved by increasing the sensitivity of the movement of the symbol image 11d with respect to the movement of the instruction marker 61.

In addition, as brightness of the instruction marker 61 in the imaging range 12a is higher, it can be more certain to estimate that the laser pointer 60 is positioned close to the projection surface 6a. Thus, as the brightness of the detected instruction marker 61 is lower, that is, as a situation where the laser pointer 60 is estimated to be positioned far from the projection surface 6a is more likely to occur, the control device 14 may perform stronger low-pass filtering processing on the detection result of the position of the instruction marker 61.

In addition, the control device 14 may combine the size and the brightness of the instruction marker 61 and, as the detected instruction marker 61 is larger, and as the brightness of the detected instruction marker 61 is lower, perform stronger low-pass filtering processing on the detection result of the position of the instruction marker 61.

As described above, the control device 14 may change the predetermined condition of the change in the position of the instruction marker 61 for not changing the position of the symbol image 11d in the projection image 11b, based on at least any of the size or the brightness of the detected instruction marker 61.

### <Changing of Size of Symbol Image 11d Based on Size or Like of Detected Instruction Marker 61>

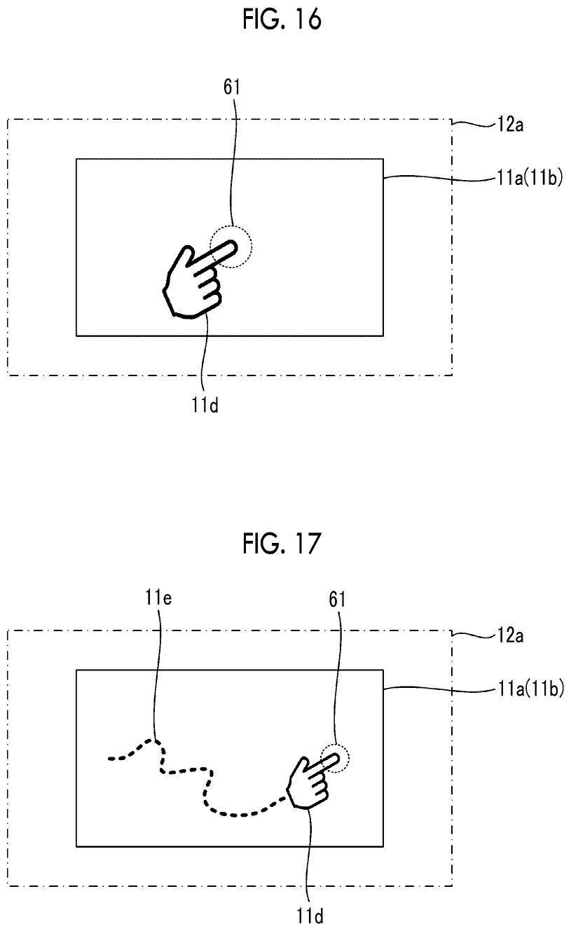

FIG. 16 is a diagram illustrating an example of changing of a size of the symbol image 11d based on the size or the like of the detected instruction marker 61. In the example in FIG. 16, the instruction marker 61 in the imaging range 12a is large compared to that in the example in FIG. 13 or the like. In this case, the laser pointer 60 and the user U can be estimated to be positioned far from the projection surface 6a compared to that in the example in FIG. 13 or the like. In this case, the control device 14 may increase the size of the symbol image 11d in the projection image 11b compared to that in the example in FIG. 13 or the like.

For example, as the detected instruction marker 61 is larger, that is, as a situation where the user U is estimated to be positioned far from the projection surface 6a is more likely to occur, the control device 14 increases the size of the symbol image 11d. Accordingly, as a situation where the user U is positioned far from the projection surface 6a and it is difficult to visually recognize the symbol image 11d is more likely to occur, deterioration in the visibility of the symbol image 11d can be suppressed by increasing the size of the symbol image 11d.

In addition, as the brightness of the instruction marker 61 in the imaging range 12a is higher, it can be more certain to estimate that the laser pointer 60 and the user U are positioned close to the projection surface 6a. Thus, as the brightness of the detected instruction marker 61 is lower, that is, as a situation where the user U is estimated to be positioned far from the projection surface 6a is more likely to occur, the control device 14 may increase the size of the symbol image 11d.

In addition, the control device 14 may combine the size and the brightness of the instruction marker 61 and, as the detected instruction marker 61 is larger, and as the brightness of the detected instruction marker 61 is lower, increase the size of the symbol image 11d. As described above, the control device 14 may change the size of the symbol image 11d in the projection image 11b based on at least any of the size or the brightness of the detected instruction marker 61.

<Display of Path of Movement of Symbol Image 11d>

FIG. 17 is a diagram illustrating an example of display of a path of the movement of the symbol image 11d. The control device 14 may display a path image 11e in a superimposed manner on the projection image 11b. The path image 11e is an image representing a path of a change in the position of the symbol image 11d in the projection image 11b.

For example, the control device 14 generates and stores history data of the position (for example, the position of the fingertip or a center position) of the symbol image 11d in the projection image 11b and generates the path image 11e based on the history data. The control device 14 displays the path image 11e in a superimposed manner on the projection image 11b together with the symbol image 11d. Accordingly, the observer such as the user U can easily recognize the change in the position of the symbol image 11d.

In addition, by generating and storing the history data of the change of the symbol image 11d in the projection image 11b, the control device 14 can display the change of the symbol image 11d in the projection image 11b later in a reproduced manner based on the history data or use the history data for data analysis, machine learning, or the like.

<Restriction of Direction of Change in Position of Symbol Image 11d in Projection Image 11b>

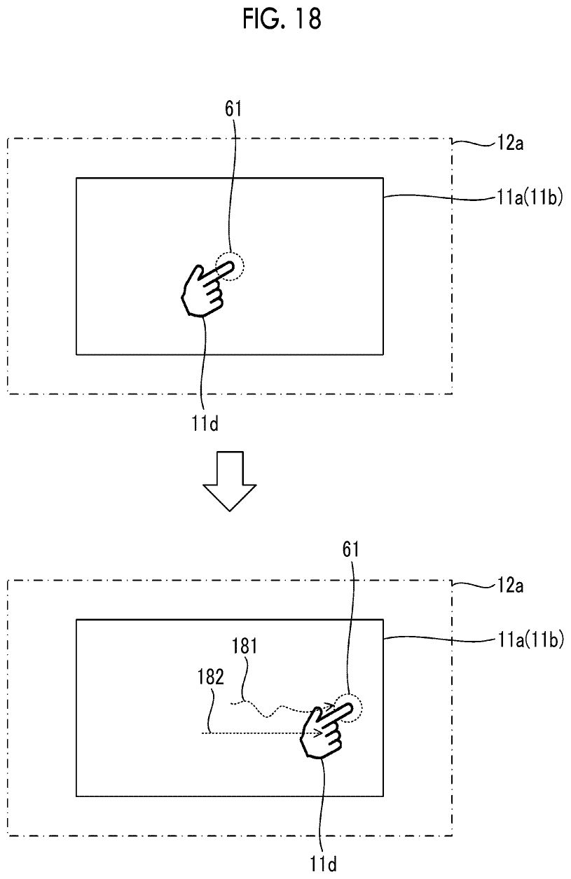

FIG. 18 is a diagram illustrating an example of restriction of a direction of the change in the position of the symbol image 11d in the projection image 11b. The control device 14 may perform a control of restricting the direction of the change in the position of the symbol image 11d in the projection image 11b.

A marker path 181 illustrated in FIG. 18 is a virtual illustration of a path of the movement of the instruction marker 61. In the example of the marker path 181 in FIG. 18, the instruction marker 61 moves to the right while meandering.

Meanwhile, for example, the control device 14 restricts a moving direction of the symbol image 11d to only a horizontal (lateral) direction. Specifically, the control device 14 causes the position of the symbol image 11d in the horizontal direction to follow the change in the position of the instruction marker 61 in the horizontal direction and does not cause the position of the symbol image 11d to follow the change in the position of the instruction marker 61 in a vertical direction. A symbol image path 182 is a virtual illustration of the path of the movement of the symbol image 11d.

Accordingly, even in a case where the instruction marker 61 shakes in the vertical direction because of the camera shake or the like, the shaking is not reflected in the symbol image 11d in a situation where the symbol image 11d may be moved in only the horizontal direction. Thus, an operation of moving the symbol image 11d is easily performed.

### <Change of Symbol Image 11d Based on Change in Position of Instruction Marker 61>

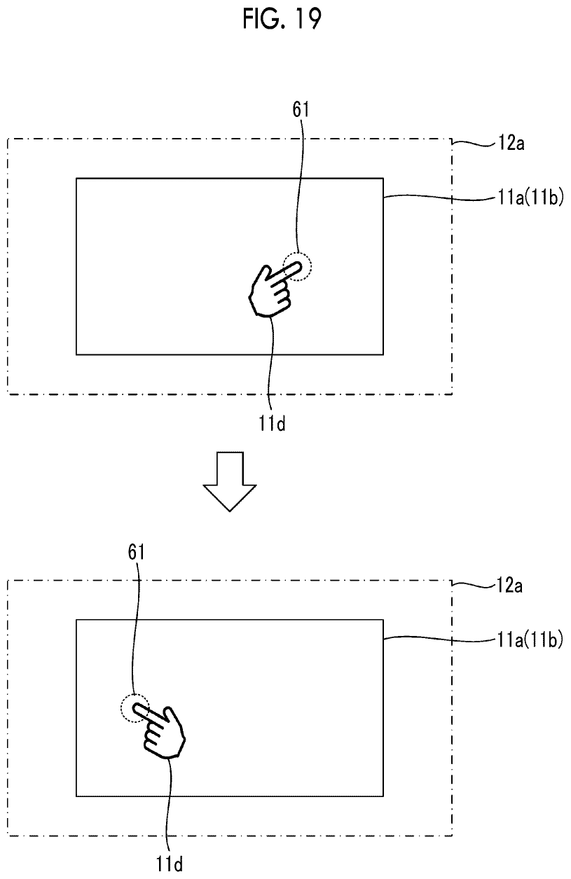

FIG. 19 is a diagram illustrating an example of changing of the symbol image 11d based on the change in the position of the instruction marker 61. The control device 14 may change the symbol image 11d based on the change in the position of the instruction marker 61 in the projection image 11b.

For example, as illustrated in FIG. 19, in a case where the instruction marker 61 has moved in a leftward direction, the control device 14 moves the symbol image 11d in the leftward direction following the instruction marker 61 and performs processing of replacing the symbol image 11d with a finger image indicating the leftward direction. In addition, in a case where the instruction marker 61 has moved in the rightward direction, the control device 14 moves the symbol image 11d in the rightward direction following the instruction marker 61 and performs processing of replacing the symbol image 11d with a finger image indicating the rightward direction.

Accordingly, the observer such as the user U can more intuitively recognize the position and a moving direction of the instruction marker 61.

### <Holding of Position of Symbol Image 11d in Case Where Instruction Marker 61 Is Not Detectable Anymore>

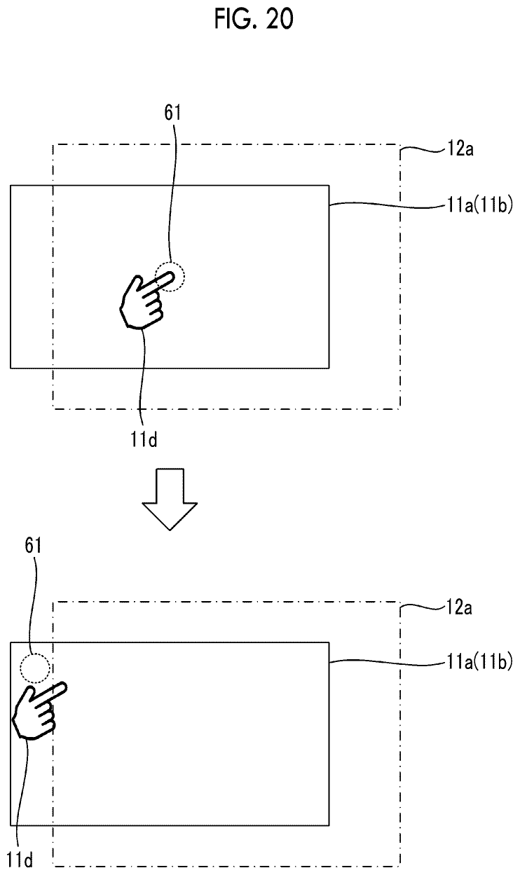

FIG. 20 is a diagram illustrating an example of holding of the position of the symbol image 11d in a case where the instruction marker 61 is not detectable anymore. In the example in FIG. 20, a left end part of the projection region 11a falls outside the imaging range 12a. It is assumed that the instruction marker 61 has moved to the upper left from a position near a center of the projection region 11a, and the instruction marker 61 has moved to a position that is included in the projection region 11a and not included in the imaging range 12a.

In this case, the control device 14 moves the symbol image 11d following the movement of the instruction marker 61, but the instruction marker 61 is not detectable anymore at a time point at which the instruction marker 61 falls outside the imaging range 12a. At the time point at which the instruction marker 61 is not detectable anymore, the control device 14 holds the position of the symbol image 11d at its position at the time point. Then, in a case where a state where the instruction marker 61 returns to the imaging range 12a and the instruction marker 61 can be detected occurs, the control device 14 resumes processing of moving the symbol image 11d following the movement of the instruction marker 61.

Accordingly, the observer such as the user U can easily recognize the instruction marker 61 falling outside the imaging range 12a or a position at which the instruction marker 61 falls outside the imaging range 12a.

### <Inability to Detect Instruction Marker 61>

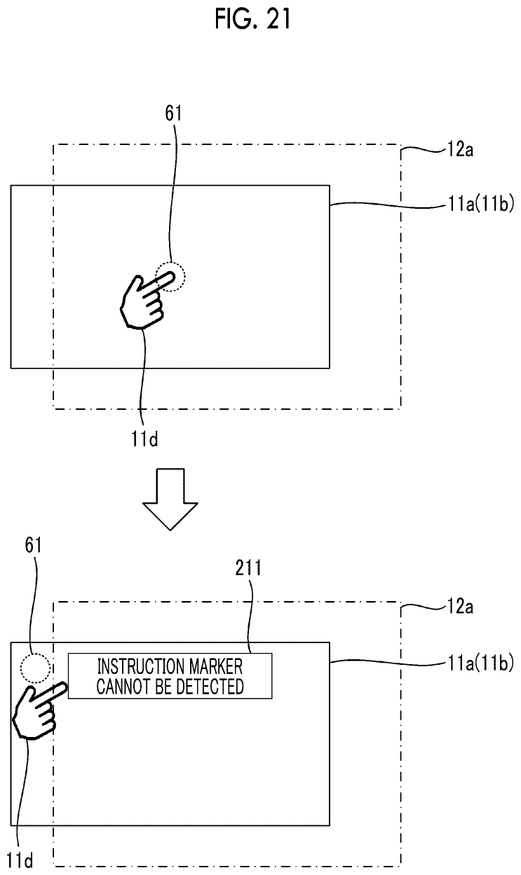

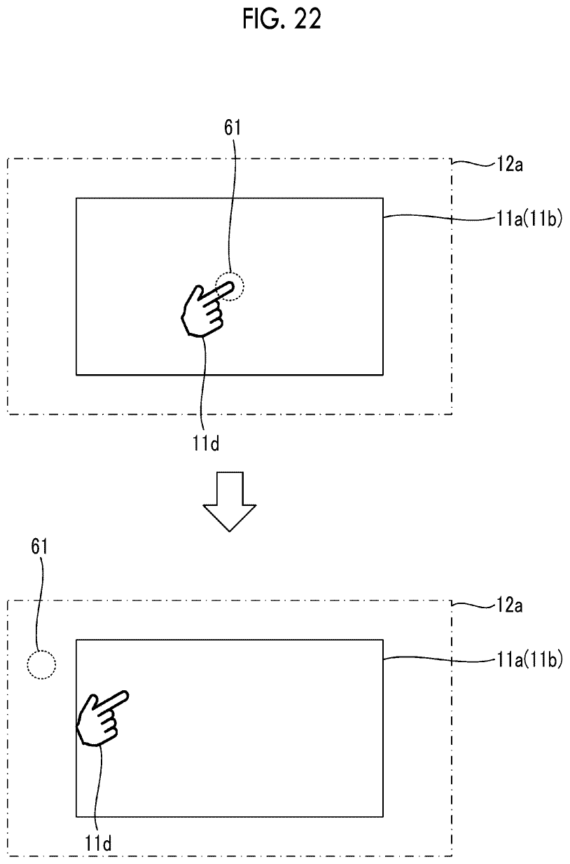

FIG. 21 is a diagram illustrating an example of display of an image indicating an inability to detect the instruction marker 61. In the example illustrated in FIG. 20, in a case where the instruction marker 61 that has been detected so far is not detectable anymore, the control device 14 may display a notification image 211 indicating the inability to detect the instruction marker 61 in a superimposed manner on the projection image 11b, as illustrated in FIG. 21.

### <Display of Symbol Image 11d in Case Where Position of Symbol Image 11d Is Not Changeable Anymore>

FIG. 22 is a diagram illustrating an example of display of the symbol image 11d in a case where the position of the symbol image 11d is not changeable anymore. For example, as illustrated in FIG. 22, it is assumed that the instruction marker 61 has moved to the upper left from a position near the center of the projection region 11a, and the instruction marker 61 has moved to a position outside the projection region 11a.

In this case, the control device 14 moves the symbol image 11d following the movement of the instruction marker 61, but the symbol image 11d is not movable anymore following the movement of the instruction marker 61 in the middle of its movement. In this case, the control device 14 displays the symbol image 11d at a position corresponding to the position of the instruction marker 61 in a region of the projection image 11b in which the symbol image 11d is displayable.

For example, the control device 14 displays the symbol image 11d at a position closest to the instruction marker 61 on a straight line connecting the instruction marker 61 to the center of the projection image 11b in the region of the projection image 11b in which the symbol image 11d is displayable.

Accordingly, the observer such as the user U can easily recognize the symbol image 11d being unable to follow the instruction marker 61 because the instruction marker 61 has moved outside the projection region 11a, or an approximate position of the instruction marker 61 that has moved outside the projection region 11a.

### <Change of Symbol Image 11d Based on State of Instruction Marker 61>

For example, it is assumed that a state of the instruction marker 61 can be changed through an operation of the laser pointer 60. For example, the state of the instruction marker 61 includes at least any of the color of the instruction marker 61, a shape of the instruction marker 61, a size of the instruction marker 61, or a period of blinking display of the instruction marker 61.

In this case, the control device 14 may change the symbol image 11d based on the state of the instruction marker 61. Accordingly, the user U can change the symbol image 11d by changing the state of the instruction marker 61 through the operation or the like of the laser pointer 60 in accordance with an environment around the projection surface 6a, content of the projection image 11b, or the like.

<Display of Symbol Image 11d at Position Different from Position of Instruction Marker 61>

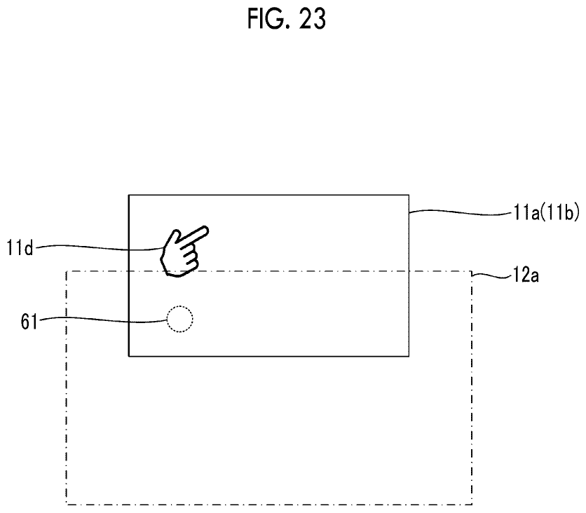

FIG. 23 is a diagram illustrating an example of display of the symbol image 11d at a position different from the position of the instruction marker 61. In the example in FIG. 23, the center of the projection region 11a deviates upward from a center of the imaging range 12a, and an upper portion of the projection region 11a falls outside the imaging range 12a.

In this case, the control device 14 may display the symbol image 11d such that a relative position of the symbol image 11d in the projection image 11b is in a relationship of being different from a relative position of the instruction marker 61 in the imaging range 12a, instead of displaying the symbol image 11d at the position of the instruction marker 61 in the projection image 11b. Accordingly, as in the example in FIG. 23, the symbol image 11d can be displayed even in a region of the projection region 11a falling outside the imaging range 12a through an intuitive operation.

Furthermore, in the example in FIG. 23, the control device 14 performs the processing for reducing the visibility of the instruction marker 61, as in the example in FIG. 8. Accordingly, even in a case of displaying the symbol image 11d at a position different from the position of the instruction marker 61, the effect of the instruction marker 61 on the visibility of the projection image 11b can be suppressed by reducing the visibility of the instruction marker 61.

As described above, the control device 14 may display the symbol image 11d at a position different from the position of the instruction marker 61 in the projection image 11b in accordance with a difference between the projection region 11a (first region) to which the projection image 11b is projected on the projection surface 6a and the imaging range 12a (second region) in which the instruction marker 61 can be detected on the projection surface 6a. In this case, in a case where the instruction marker 61 is present in the projection region 11a, the control device 14 may change the partial region of the projection image 11b based on the position of the instruction marker 61 such that the visibility of the instruction marker 61 is reduced.

### Another Example of Processing Performed by Control Device 14

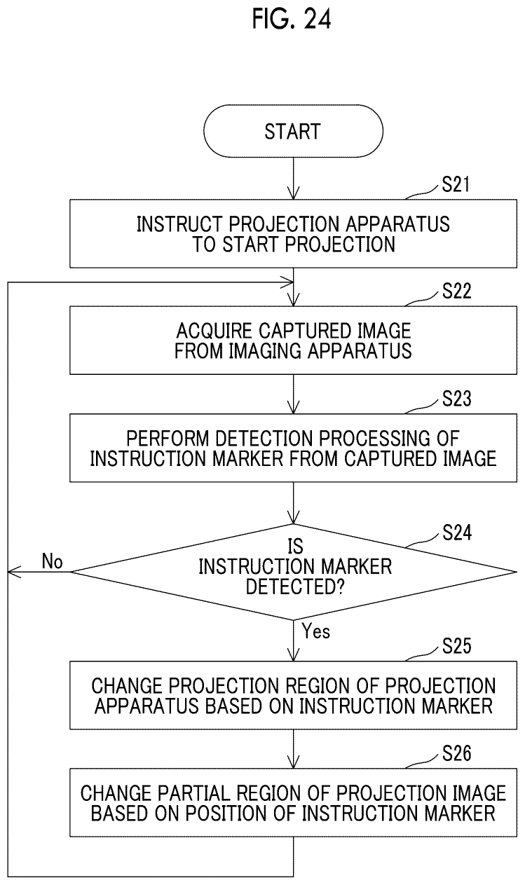

FIG. 24 is a flowchart illustrating another example of the processing performed by the control device 14. The control device 14 executes, for example, processing illustrated in FIG. 24. Steps S21 to S24 illustrated in FIG. 24 are the same as steps S11 to S14 illustrated in FIG. 7.

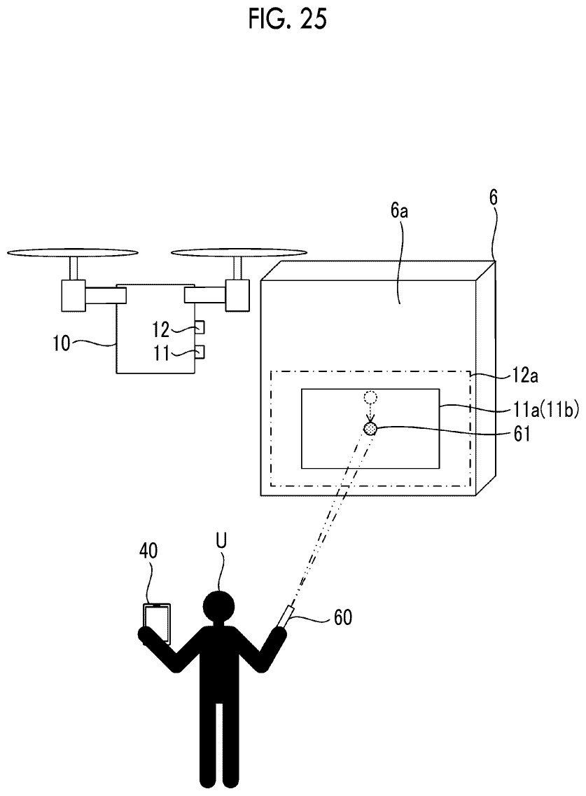

In step S24, in a case where the instruction marker 61 is detected (step S24: Yes), the control device 14 changes the projection region 11a of the projection apparatus 11 based on the detected instruction marker 61 (step S25). Changing of the projection region 11a of the projection apparatus 11 based on the instruction marker 61 will be described later (for example, refer to FIG. 25).

Next, the control device 14 changes the partial region based on the position of the detected instruction marker 61 (step S26) and returns to step S22. Processing in step S26 is the same processing as step S15 illustrated in FIG. 7.

### <Changing of Position of Projection Region 11a by Moving Instruction Marker 61>

FIG. 25 is a diagram illustrating an example of changing of a position of the projection region 11a by moving the instruction marker 61. In step S25 illustrated in FIG. 24, for example, the control device 14 changes the position of the projection region 11a with reference to the position of the instruction marker 61 on the projection surface 6a. For example, the control device 14 changes the position of the projection region 11a such that a center position of the projection region 11a matches the position of the instruction marker 61.

The position of the projection region 11a may be changed by instructing the projection apparatus 11 to perform the various types of shifting or change the projection direction, by instructing the moving mechanism 16 to change at least any of a position or a posture of the moving object 10, or by a combination thereof.

For example, in the state illustrated in FIG. 6, it is assumed that the user U has moved the position of the instruction marker 61 downward as illustrated in FIG. 25 by operating the laser pointer 60. In this case, the control device 14 moves the projection region 11a downward such that the center position of the projection region 11a matches the position of the instruction marker 61 after movement. In the example in FIG. 25, the control device 14 moves the projection region 11a downward by moving the moving object 10 downward.

For example, the control device 14 acquires the information indicating the positional relationship between the projection region 11a and the imaging range 12a and information indicating positional relationships (for example, distances) between the projection surface 6a and the projection apparatus 11 and the imaging apparatus 12. For example, the information about the positional relationships between the projection surface 6a and the projection apparatus 11 and the imaging apparatus 12 is acquired by distance measurement means comprised in the moving object 10. Based on these types of information, the control device 14 calculates a control parameter (for example, a moving direction and a moving amount of the moving object 10) for matching the center position of the projection region 11a to the position of the instruction marker 61 and performs a control of moving the projection region 11a using the calculated control parameter.

Accordingly, the user U can move the projection region 11a by moving the instruction marker 61 by operating the laser pointer 60.

In addition, the control device 14 may change the position of the projection region 11a based on not only the position of the detected instruction marker 61 but also the state of the detected instruction marker 61. As described above, for example, the state of the instruction marker 61 includes at least any of the color of the instruction marker 61, the shape of the instruction marker 61, the size of the instruction marker 61, or the period of blinking display of the instruction marker 61. For example, the control device 14 changes the position of the projection region 11a based on the color of the detected instruction marker 61.

In addition, the control device 14 may change not only the position of the projection region 11a but also a size of the projection region 11a based on the position or the state of the detected instruction marker 61. For example, the control device 14 increases the size of the projection region 11a in a case where upward movement of the instruction marker 61 is detected, and reduces the size of the projection region 11a in a case where downward movement of the instruction marker 61 is detected. The size of the projection region 11a may be changed by instructing the projection apparatus 11 to perform optical or electronic enlargement or reduction, by instructing the moving mechanism 16 to change the position of the moving object 10, or by a combination thereof.

### Modification Example

### Modification Example of Instruction Marker 61

While a case where the instruction marker 61 is provided by a visible ray projected to the projection surface 6a has been described, the instruction marker 61 is not limited to this and may be provided by an invisible ray (for example, an infrared ray) projected to the projection surface 6a as long as the instruction marker 61 can be detected based on the captured image obtained by the imaging apparatus 12. In this case, for example, the effect of the instruction marker 61 on the visibility of the projection image 11b can be suppressed without performing the processing for reducing the visibility of the instruction marker 61 as described in FIG. 8.

In addition, while a case where the instruction marker 61 is provided by the laser pointer 60 carried by the user U has been described, the instruction marker 61 is not limited to this. For example, the instruction marker 61 may be provided by irradiation light from an irradiation apparatus positioned at a different location from the user U. In addition, the instruction marker 61 may be an object (for example, a moving robot) that can move on the projection surface 6a.

### Modification Example of Method of Changing Projection Image 11b

While a case where the partial region of the projection image 11b is changed based on the position of the instruction marker 61 has been described, the control device 14 may change the partial region of the projection image 11b based on the color, the shape, the size, the blinking period, or the like of the instruction marker 61 in a case where the user U can control the color, the shape, the size, the blinking period, or the like of the instruction marker 61.

<Blinking of Projection Image 11b>

The control device 14 may instruct the projection apparatus 11 to cause the projection image 11b to blink. Accordingly, the control device 14 can accurately detect the instruction marker 61 based on the captured image of the imaging apparatus 12 at a timing at which the projection image 11b is not displayed. This blinking of the projection image 11b is desirably performed without affecting observation of the projection image 11b by the observer such as the user U.

In addition, the laser pointer 60 may perform blinking of the irradiation light. Accordingly, the instruction marker 61 blinks on the projection surface 6a. In this case, the control device 14 may specify a blinking timing of the instruction marker 61 based on the captured image of the imaging apparatus 12, do not display the projection image 11b during a period in which the instruction marker 61 is displayed, and display the projection image 11b during a period in which the instruction marker 61 is not displayed. Accordingly, during the period in which the projection image 11b is not displayed, the instruction marker 61 can be displayed, and the instruction marker 61 can be accurately detected. During the period in which the projection image 11b is displayed, the instruction marker 61 is not displayed. Thus, deterioration in the visibility of the projection image 11b caused by the instruction marker 61 can be suppressed.

### Other Examples of Moving Object 10

While a configuration in which the moving object 10 is a multicopter has been described, the moving object 10 may be an aircraft (flying object) other than a multicopter. In addition, the moving object 10 is not limited to a flying object and may be a vehicle, a robot, or the like that travels or walks on the ground. In addition, the projection apparatus 11, the imaging apparatus 12, and the control device 14 may not be configured to be mounted on the moving object 10.

### Other Examples of Projection Apparatus 11

While a configuration in which the projection apparatus 11 is mounted on the moving object 10 has been described, the present invention is not limited to this configuration. For example, the projection apparatus 11 may be a projection apparatus fixed to the ground or may be a projection apparatus provided in the information terminal 40.

### Other Examples of Imaging Apparatus 12

While a configuration in which the imaging apparatus 12 is mounted on the moving object 10 has been described, the present invention is not limited to this configuration. For example, the imaging apparatus 12 may be an imaging apparatus fixed to the ground or may be an imaging apparatus provided in the information terminal 40.

### Other Examples of Control Device

While a case where the control device according to the embodiment of the present invention is applied to the control device 14 of the moving object 10 has been described, the present invention is not limited to this configuration. The control device according to the embodiment of the present invention may be applied to, for example, the information terminal 40. In this case, the information terminal 40 executes the same controls as the various controls performed by the control device 14 by communicating with the moving object 10.

While various embodiments have been described above, the present invention is, of course, not limited to such examples. It is apparent that those skilled in the art may perceive various modification examples or correction examples within the scope according to the claims, and those examples are also understood as falling within the technical scope of the present invention. In addition, constituents in the embodiment may be used in any combination with each other without departing from the gist of the invention.

The present application is based on Japanese Patent Application (JP2022-081603) filed on May 18, 2022, the content of which is incorporated in the present application by reference.

### Explanation of References

6: projection target object
6a: projection surface
10: moving object
11: projection apparatus
11a: projection region
11b: projection image
11c: highlight image
11d: symbol image
11e: path image
12: imaging apparatus
12a: imaging range
14: control device
14a: storage medium
15: communication unit
16: moving mechanism
31: light source
32: optical modulation unit
33: projection optical system
34: control circuit
40: information terminal
41: processor
42: memory
43: communication interface
44: user interface
49: bus
60: laser pointer
61: instruction marker
181: marker path
182: symbol image path
211: notification image

What is claimed is:

1. A control device comprising:
a processor,
wherein the processor is configured to:
instruct a projection apparatus to project a first image to a projection surface;
acquire a second image obtained by imaging the projection surface via an imaging apparatus;
detect a specific marker from the second image;
change a partial region of the first image based on a position of the marker; and
change the partial region such that visibility of the marker is reduced.

2. The control device according to claim 1,
wherein the processor is configured to display a specific symbol image in the partial region of the first image.

3. The control device according to claim 2,
wherein the processor is configured to change a position of the symbol image in the first image in accordance with a change in the position of the marker.

4. The control device according to claim 3,
wherein the processor is configured to, in a case where the change in the position of the marker satisfies a predetermined condition, not change the position of the symbol image in the first image in accordance with the change in the position of the marker.

5. The control device according to claim 4,
wherein the processor is configured to change the predetermined condition based on at least one of a size or brightness of the detected marker.

6. The control device according to claim 4,
wherein the processor is configured to change a size of the symbol image in the first image based on at least one of a size or brightness of the detected marker.

7. The control device according to claim 3,
wherein the processor is configured to display an image representing a path of a change in a position of the symbol image in the first image, on the first image.

8. The control device according to claim 3,
wherein the processor is configured to generate history data of a change of the symbol image in the first image.

9. The control device according to claim 3,
wherein the processor is configured to restrict a direction of a change in the position of the symbol image in the first image.

10. The control device according to claim 3,
wherein the processor is configured to change the symbol image based on the change in the position of the marker in the first image.

11. The control device according to claim 3,
wherein the processor is configured to hold the position of the symbol image in a case where the detected marker is not detectable anymore.

12. The control device according to claim 3,
wherein the processor is configured to, in a case where the position of the symbol image in the first image is not changeable anymore in accordance with the change in the position of the marker, display the symbol image at a position corresponding to the position of the marker in a region of the first image in which the symbol image is displayable.

13. The control device according to claim 2,
wherein the processor is configured to change the symbol image based on a state of the marker.

14. The control device according to claim 13,
wherein the state of the marker includes at least one of a color of the marker, a shape of the marker, a size of the marker, or a period of blinking display of the marker.

15. The control device according to claim 2,
wherein the processor is configured to:
display the symbol image at a position different from the position of the marker in the first image in accordance with a difference between a first region to which the first image is projected on the projection surface and a second region in which the marker is detectable on the projection surface; and
in a case where the marker is present in the first region, change the partial region such that visibility of the marker is reduced.

16. The control device according to claim 1,
wherein the processor is configured to, in a case where the detected marker is not detectable anymore, display an image indicating that the marker is not detectable, on the first image.

17. The control device according to claim 1,
wherein the marker is provided by an invisible ray projected to the projection surface.

18. The control device according to claim 1,
wherein the processor is configured to instruct the projection apparatus to change at least one of a position or a size of a projection region in accordance with a detection result of the marker.

19. The control device according to claim 1,
wherein the processor is configured to instruct the projection apparatus to cause the first image to blink.

20. A moving object comprising:
the control device according to claim 1;
the projection apparatus; and
the imaging apparatus,
wherein the control device is capable of performing a moving control of the moving object.

21. The moving object according to claim 20,
wherein the processor is configured to perform the moving control for changing at least one of a position or a size of a projection region of the projection apparatus in accordance with a detection result of the marker.

22. A control method comprising:
via a processor,
instructing a projection apparatus to project a first image to a projection surface;
acquiring a second image obtained by imaging the projection surface via an imaging apparatus;
detecting a specific marker from the second image; and
changing a partial region of the first image based on a position of the marker.

23. A non-transitory computer-readable storage medium that stores a control program causing a processor to execute a process, the process comprising:
instructing a projection apparatus to project a first image to a projection surface;
acquiring a second image obtained by imaging the projection surface via an imaging apparatus;
detecting a specific marker from the second image; and
changing a partial region of the first image based on a position of the marker.

24. A control device comprising:
a processor,
wherein the processor is configured to:
instruct a projection apparatus to project a first image to a projection surface;
acquire a second image obtained by imaging the projection surface via an imaging apparatus;
detect a specific marker from the second image;
change a partial region of the first image based on a position of the marker; and
display a specific symbol image in the partial region of the first image; and
change the symbol image based on a state of the marker,
the state of the marker includes at least one of a shape of the marker, a size of the marker, or a period of blinking display of the marker.
